(19) United States
(12) Patent Application Publication
(10) Pub. No.: US 2008/0071887 A1
(43) Pub. Date: Mar. 20, 2008

(54) INTELLIGENT TRANSLATION OF ELECTRONIC DATA INTERCHANGE DOCUMENTS TO EXTENSIBLE MARKUP LANGUAGE REPRESENTATIONS

(75) Inventors: Suraj Gaurav, Issaquah, WA (US); Surendra Machiraju, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/533,283

(22) Filed: Sep. 19, 2006

(51) Int. Cl. G06F 15/177

(52) U.S. Cl. 709/220

(57) ABSTRACT

Intelligent, rule-based translation of EDI documents to XML representations, and vice versa, is provided. By applying EDI encoding format aware encoding rules during translation, the invention generates descriptive and meaningful XML representations, e.g., appropriately annotated tags, replacing decimal points, etc., based on the EDI encoding context. In various non-limiting embodiments of the invention, the intelligent, rule-based translation is presented as a set of configurable options.

### TECHNICAL FIELD

The subject invention relates to communications systems that translate electronic data interchange (EDI) documents to extensible markup language (XML) representations, and vice versa.

### BACKGROUND

Traditionally, with EDI, organizations have been empowered to send virtually limitless kinds of structured messages to one another to facilitate the communication of any kind of business data from one organization to another in automated ways. In this regard, once setup properly, EDI messages can be used to automate a variety of communications to and from partners, business sub-units, buyers, etc., thereby substantially reducing the overhead associated with filling out paper forms, storing volumes of papers, etc. With EDI, for instance, an organization merely fills out an electronic form in a manner conforming to a pre-defined schema, and then the messaging, storage/record keeping and validation of the message(s) associated with the electronic form occurs automatically.

In current EDI messaging scenarios, which applies to both inbound messages (i.e., where a message is received by an organization) and to outbound messages (i.e., where a message is transmitted from an organization to an intended recipient of the message), a single message can be addressed for multiple parties, and multiple messages can be received from different parties. Multiple messages can also be received from the same party as part of an Interchange, which is an EDI flat file representation of multiple transaction sets. In this regard, EDI data in its native flat file representation, e.g., an interchange that captures multiple EDI transaction sets, is generally transmitted as a delimited file, without self-describing tags, and therefore the encoding rules enforce very strict formatting rules to ensure the destination application is able to successfully parse and consume the information for down stream processing. Such files are hardly in an easily human readable form, and difficult to consume by a system or application without native understanding of EDI encoding formats.

The structure of a typical interchange 1200 is illustrated in FIG. 12. An interchange file, such as interchange 1200 begins with ‘ISA’ and ends in ‘IEA’ and then contains one or more intermediate groups of Transaction Sets, which begin with ‘GS’ and end with ‘GE. Each group then contains one or more Transaction Sets, each of which begins with ‘ST’ and ends with ‘SE’. Interchange file 1200, as shown, includes three Transaction Sets 1202, 1204 and 1206. Today, a translator component 1210 of an EDI system receives an interchange file, such as interchange file 1200, and then translates the interchange file 1200 to an XML representation. For instance, some translators 1210 will translate each of the transaction sets 1202, 1204 and 1206 to separate XML files 1222, 1224 and 1226 for further consumption by the EDI system in some fashion. A translator 1210 can also translate in the other direction from XML to EDI formatting, i.e., translator 1210 can translate the XML files 1222, 1224 and 1226 to interchange 1200.

There are a variety of reasons for translating from EDI representations to XML representations, even though EDI representations are more compact by design, one of which is that XML is more readable to humans, and if encoded with self-descriptive information, the XML version can be understood by any machine with no understanding of EDI formatting, making a translator a powerful tool. In essence, while EDI representations make for more efficient use of network transmission bandwidth, there tends to be more flexibility in handling, storing and processing of the data at the computing end points if the EDI representations are translated to XML versions.

However, today, translation of EDI transaction sets to XML representations is performed in a blind manner without any intelligence based on an understanding of the way that EDI documents are encoded. Such intelligence is instead left to higher-level applications, which must further interpret the EDI concepts encoded in the XML.

For instance, for compaction reasons, decimals today are not directly included in an EDI document for certain properties of EDI data elements, but rather the location of the decimal is implicitly specified. In this respect, the XML that is produced today as a result of translating such an EDI document also includes no decimals where they should appear because no logic is applied based on encoding rules enforced for EDI documents. Instead, the “decimal-less” numbers are encoded straight to “decimal-less” numbers in the XML representation, leaving the task of understanding and interpreting where the decimal should be to the determinations of higher level applications.

There is thus no flexibility to apply intelligence during the translation process itself in order to provide a richer, more self-describing XML document based on underlying concepts encoded in EDI representations. Accordingly, in consideration of the deficiency of the state of the art of interchange translation techniques in an EDI communications system, smarter ways for translating groups of EDI transaction sets to XML representations are desired. The above-described and other deficiencies in the state of the art of EDI messaging will become apparent upon description of the various exemplary non-limiting embodiments of the invention set forth in more detail below.

### SUMMARY

In consideration of the foregoing, the invention provides intelligent, rule-based translation of EDI documents to XML representations, and vice versa. By applying EDI encoding format aware encoding rules during translation, the invention generates descriptive and meaningful XML representations, e.g., appropriately annotated tags, replaced decimal points, etc., based on the EDI context. In various non-limiting embodiments of the invention, the intelligent, rule-based translation is a configurable option.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The system and methods for translating interchanges to XML in accordance with the present invention are further described with reference to the accompanying drawings in which:

FIG. 1 is a block diagram of exemplary, non-limiting embodiments of a translator component for intelligently translating an interchange to XML representation(s) in accordance with the invention;

FIG. 2 is a block diagram of an exemplary system employing the translation processes for translating groups of transaction sets to XML representation(s) in accordance with the invention;

FIG. 3 is a flow diagram of exemplary, non-limiting processes for configuring the translation of groups of transaction sets to XML representation(s) in accordance with the invention;

FIG. 4 illustrates exemplary translation of a representative EDI snippet to XML in accordance with an option to convert implicit information to explicit information in accordance with the invention;

FIG. 5 is a flow diagram of exemplary, non-limiting processes for configuring the translation of groups of transaction sets to XML representation(s) in accordance with the invention;

FIG. 6 illustrates exemplary translation of a representative EDI snippet to XML in accordance with an option to annotate tags in a descriptive manner in accordance with the invention;

FIG. 7 illustrates an exemplary implementation based on trigger fields in accordance with the invention;

FIG. 8 illustrates exemplary, non-limiting configuration UI for configuring translation of interchanges to XML representation(s) according to the various embodiments of the invention;

FIG. 9 is an exemplary block diagram of a representative EDI communications system between a home organization having a server and the trading partners of the home organization;

FIG. 10 is an exemplary block diagram of a representative EDI system including a hub and spoke architecture;

FIG. 11 is an exemplary block diagram representative of an interchange data structure including a plurality of EDI transactions;

FIG. 12 illustrates exemplary aspects of a first option enabled by a configuration component of the present invention;

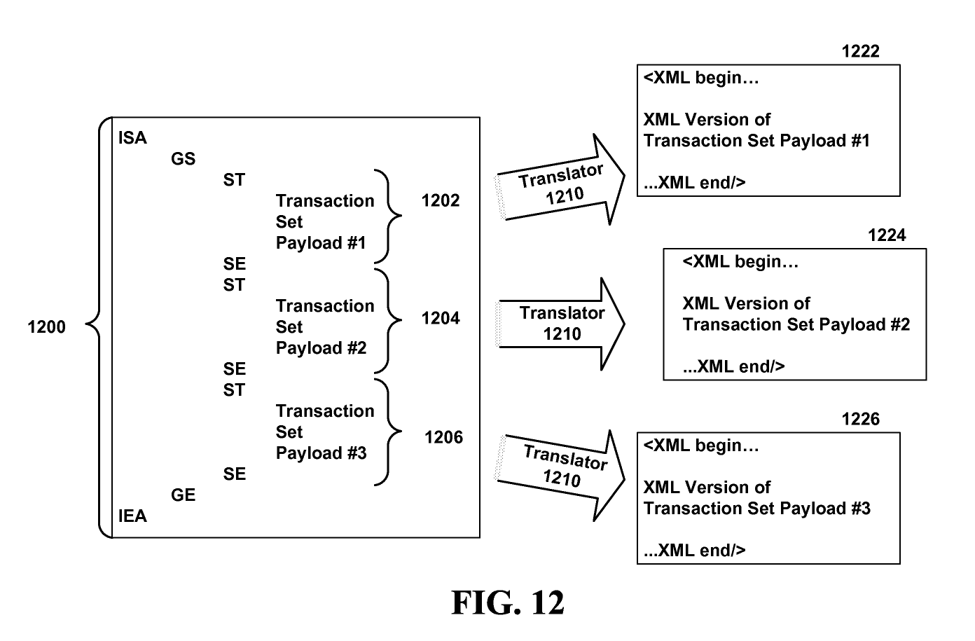

FIG. 13 is a block diagram representing an exemplary non-limiting networked environment in which the present invention may be implemented; and

FIG. 14 is a block diagram representing an exemplary non-limiting computing system or operating environment in which the present invention may be implemented.

### DETAILED DESCRIPTION

### Overview

In consideration of the unintelligent translation of interchanges to XML in current EDI systems, in various non-limiting embodiments, the invention provides configurable ways for translating interchanges to XML representations according to intelligent rules that apply to various EDI encoding contexts. In various non-limiting embodiments, the invention adds more descriptive annotation tags to XML representations generated by a translator in an EDI communications system. In other various non-limiting embodiments, the invention interprets EDI notation during the translation process, and expands the EDI notation to expanded form in the XML representation.

Any of the options for translating groups of transaction sets of the invention can be configured via a configuration user interface. Moreover, the rules applied one way for translation from EDI to XML documents can be applied in reverse to translate the XML documents generated according to the intelligent translation processes of the invention to EDI documents. The term ‘SmartXML’ is sometimes used herein to refer to XML representations generated according to the rule-based translation techniques of the invention.

### Translating from EDI to XML and Vice Versa

EDI is a typical choice of encoding for communications between partners in a B2B communication paradigm; however, XML is the choice of encoding for rendering such data in human readable forms and for back end integration. The cryptic nature of EDI does not render it as human readable or does not ease the integration process.

As mentioned, by design, EDI transmissions are minimized for size using cryptic code values instead of descriptions. As one example, since the addition of a decimal to a property value of an EDI document adds to the overall size of an EDI document, the EDI encoding rules instead require that the ‘decimal’ value be left out, instead having its position implicitly specified by the data type. Such compacting of data does ease transmission and machine processing, however, consumption of such data becomes difficult because a consuming application must apply additional custom logic to determine how to use the XML data, e.g., determine where to place the decimal point in connection with actual use of the property value by the application. For example, a consuming application will have to ask whether the value “1299” represented in the XML form is supposed to be interpreted as “1299”, “129.9”, “12.99”, or “1.299”, not an easy question to answer without a solid understanding of EDI encoding rules, as encapsulated in XML form.

Accordingly, as part of the translation process, the invention optionally operates according to configuration to include a decimal in the associated property value at the appropriate place when generating SmartXML output. For each EDI data element examined during translation, when configured for generation of SmartXML, the invention automatically examines the EDI data element and determines if decimals are implicated by the EDI data elements according to EDI encoding rules. If so, the invention operates to add the decimal place in the SmartXML representation automatically, freeing applications to use the values encoded in the SmartXML directly without requiring interpretive capabilities for understanding the underlying EDI encoding logic.

As mentioned, the invention applies rule-based translation of EDI documents to generate a smarter form of XML representation than has been generated in the past. Current EDI translators only convert the direct encoding from EDI to XML and leave further interpretation to higher-level applications. The invention makes the XML generated much more legible by ‘de-compacting’ or expanding the relevant EDI elements in a contextual manner, rendering the XML generated ‘smart.’

Another exemplary non-limiting way in which the translation techniques of the invention make XML smarter is by generating contextual XML with appropriately annotated tags. For instance, if it is known by the nature of a particular TSD for an EDI system, that the Address field is always a Shipping Address, rather than blindly creating a generic address field in the corresponding XML, the invention annotates tags in the XML to more descriptively reflect that the address is a Shipping Address, thereby making the XML more readable and readily consumable by end point machines because the data is self-describing. As with other rules applied to the generation of XML in accordance with the invention, this behavior can be controlled via configuration options

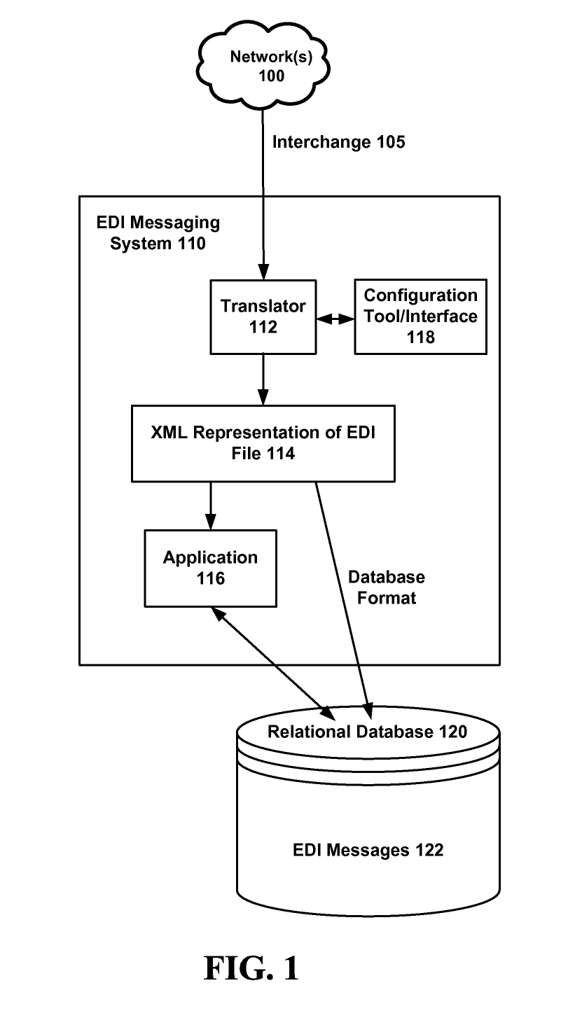

In various non-limiting embodiments, the invention intelligently translates EDI structure to XML representations, and vice versa. A typical EDI messaging scenario is depicted in FIG. 1. Via network(s) 100, or retrieved internally, an EDI messaging system 110 may operate to retrieve or receive a group of EDI transaction sets in an interchange file 105 (native EDI flat file format). The interchange 105 is processed on computer systems or components called Translators 112. A common usage of a Translator 112 is to receive the EDI and then, to encode the EDI data to another format, such as XML 114, or vice versa. XML 114 may be further used by an application 116, or stored in relational database 120 with EDI messages 122.

As described in the background, however, available translators merely convert an EDI-Interchange (including multiple transaction sets) into XML representations without taking into account the EDI context in which the translation process takes place. Accordingly, in various non-limiting embodiments, the invention optionally enables a translator 112 to apply intelligent rules to generate smarter, richer, more directly descriptive XML output. Any one or more of the intelligent rules applied to translation herein may be considered configuration options, e.g., provided by exemplary non-limiting configuration user interface.

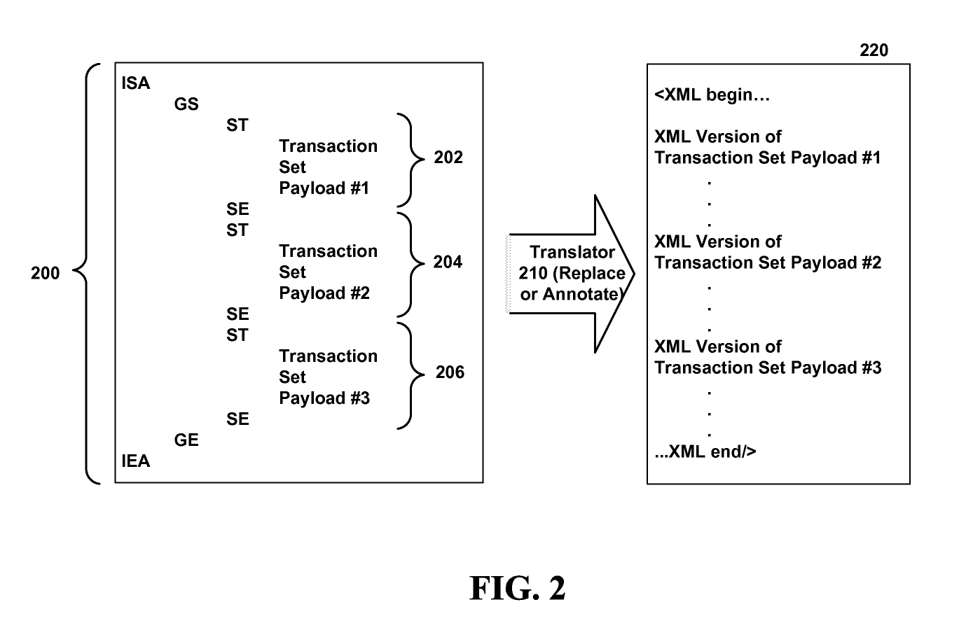

FIG. 2 is a block diagram illustrating an exemplary non-limiting system for translating interchange files to XML representation(s) in accordance with a translation component provided in accordance with the invention. A group of transaction sets 200, e.g., an interchange, is received including transaction sets 202, 204, and 206. Depending on which optional translation techniques are implemented in accordance with the invention, a translator 210 operates intelligently to translate the group of transaction sets 200 to XML 220, which may be one or more XML files. The translation may include replacing EDI encoded values with implicitly specified information with explicit information in the XML representation 220. The translation may also include annotating the XML representation 220 with more descriptive information to help disambiguate EDI data elements by mere review of the XML representation 220.

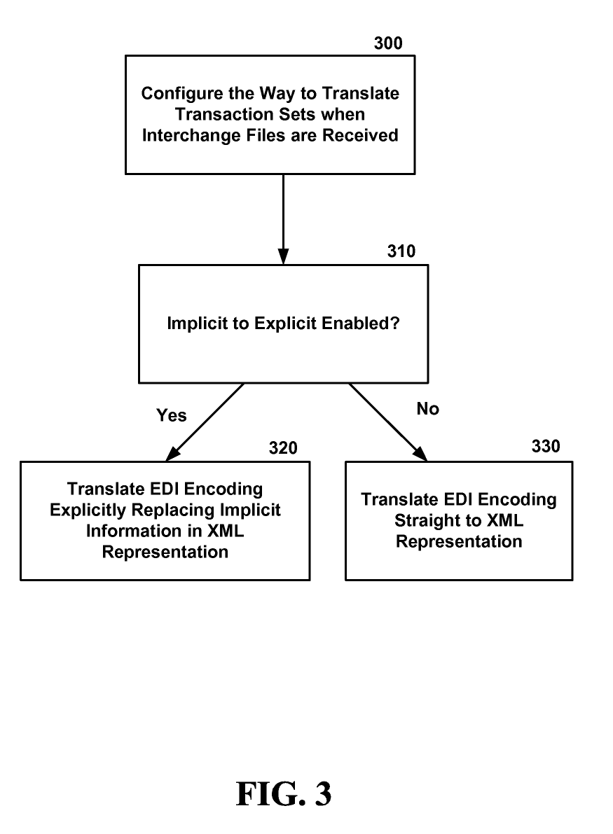

FIG. 3 is a flow diagram illustrating exemplary non-limiting processes for configuring translation of interchange files to XML representation(s) in accordance with the invention. At 300, a user may configure, via a configuration UI or other interface to an EDI messaging system, the way to translate transaction sets when interchange files are received by a translator of the EDI messaging system. At 310, a user may decide whether to enable an option to translate from EDI documents to XML by replacing implicitly identified information with explicit information. If enabled, then the translator at 320 translates implicitly identified information, e.g., the position of a decimal point in a real number, to explicit information in the XML representation, e.g., the decimal point is added back in for the real number when represented in XML. If the option is not enabled, then at 330, the translation occurs without disturbing the original EDI encoding.

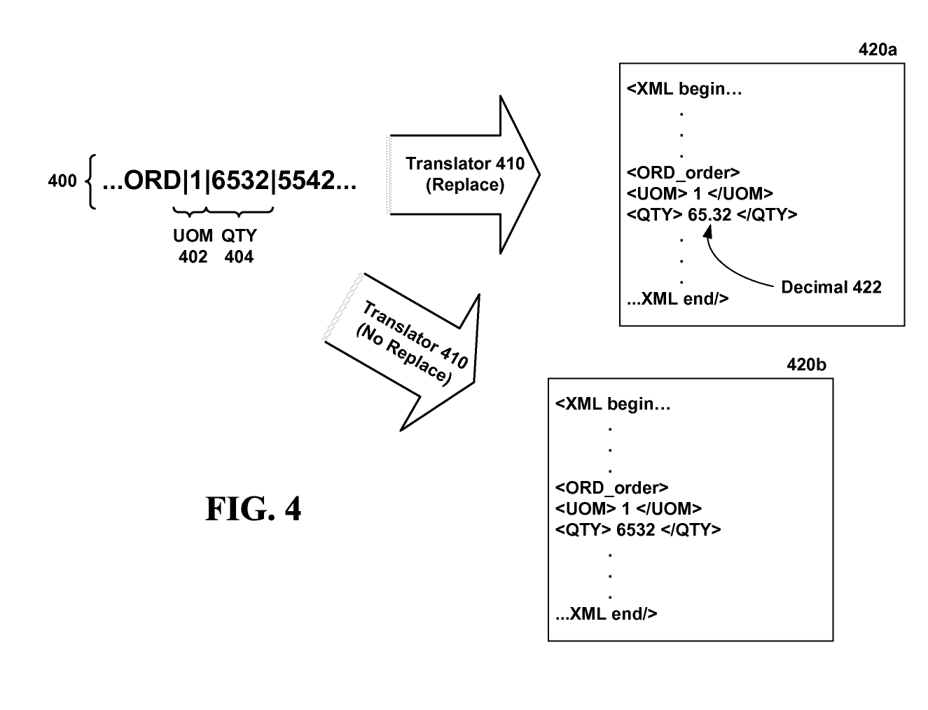

This scenario is illustrated in more detail in the block diagram of FIG. 4. In FIG. 4, EDI encoding snippet 400 is for an order form, such as an order form for gasoline, which might include an encoding 402 for the unit of measure (UOM), e.g., 1 for liters, 2 for gallons, etc., an encoding for quantity 404 for which the decimal position is implicitly specified. For instance, the position might be implicitly specified between the 5 and the 3 for the QTY data segment, e.g., two positions from the right most number. Without the intelligent rule based translation of the invention, a translator 410 produces XML representation 420b, i.e., the QTY data value is represented as it is in the EDI encoded snippet 400, i.e., without a decimal point. However, in accordance with the invention, a translator 410 can be advantageously configured to generate SmartXML representation 420a, which automatically adds the decimal point 422 according to the known implicitly specified information. This advantageously frees a consuming application from being required to understand the cryptic EDI encoding rules.

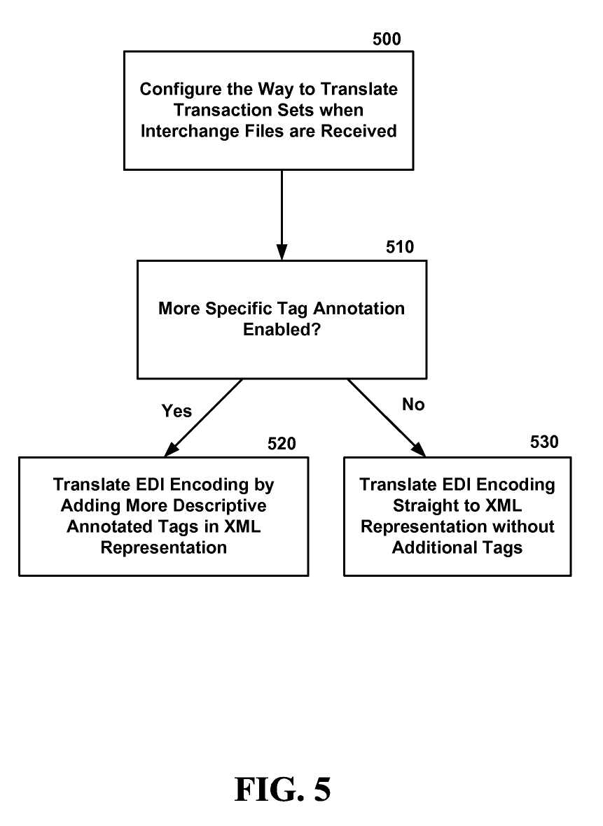

FIG. 5 is a flow diagram illustrating exemplary non-limiting processes for configuring translation of interchange files to XML representation(s) in accordance with the invention. At 500, a user may configure, via a configuration UI or other interface to an EDI messaging system, the way to translate transaction sets when interchange files are received by a translator of the EDI messaging system. At 510, a user may decide whether to enable an option to translate from EDI documents to XML by adding more descriptive annotation tags to the XML representation based on knowledge of EDI encoding. If enabled, then the translator adds more descriptive tags when naming elements of the XML representation at 520. If not enabled, then at 530, the translation occurs without using the more descriptive tags.

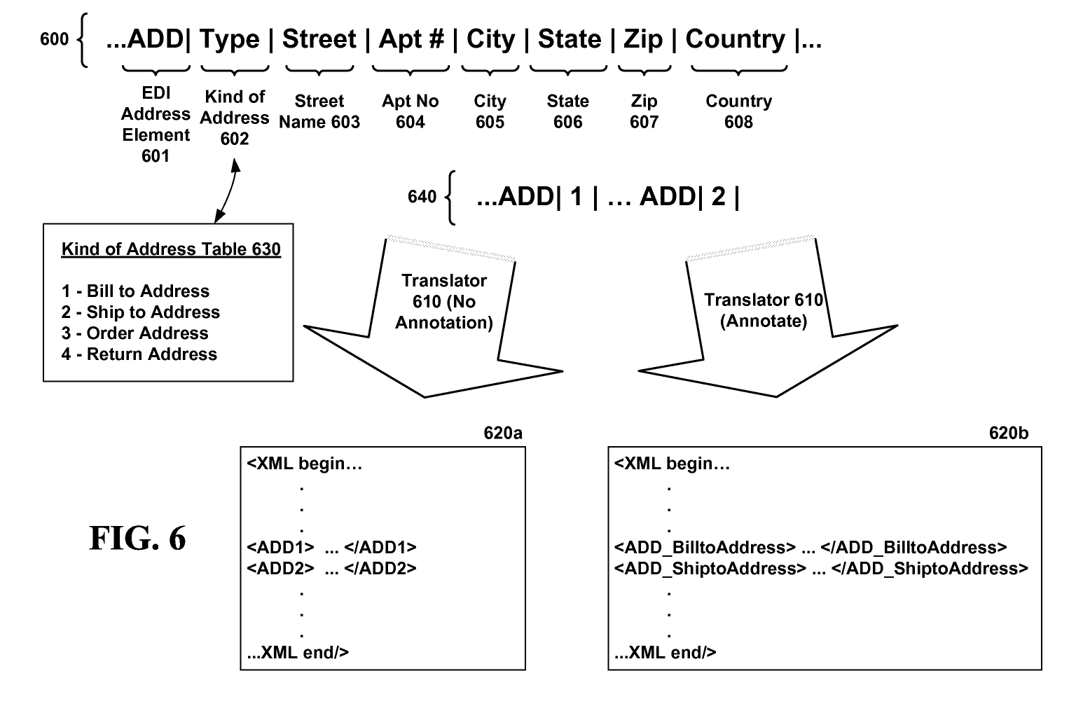

This scenario is illustrated in more detail in the block diagram of FIG. 6. In FIG. 6, EDI encoding snippet 640 specifies two separate addresses add1 and add2 of type 1 and 2, respectively. In this regard, an address 600 is generally specified according to EDI encoding rules to include an EDI Address element 601, a kind of address 602, a street name 603, an apartment number 604, a city 605, a state 606, a zip 607 and a country 608. Using EDI encoding rules reflected by kind of address table 630, the kind of address 602 maps to a numeric value that specifies the kind of address represented by EDI Address element 601. Thus, for instance, a kind of address 602 of ‘3’ means that the address is an order address, as opposed to another kind of address.

Without the annotation option enabled, a translator 610 will translate EDI code snippet 640 to XML representation 620a, i.e., while the EDI encoding information ADD of type 1 and ADD of type 2 is still represented in the XML representation 620a, it is difficult to appreciate without a deep understanding of EDI encoding rules. If the option is enabled, however, translator 610 will translate EDI code snippet 640 to XML representation 620b. Now, anyone reviewing the XML representation 620b can easily observe that the first address is a BilltoAddress and the second address is a ShiptoAddress, and so on.

The various ways for applying enumeration of EDI encoding rules is elaborated upon with additional examples presented below. As described above, in one non-limiting aspect, the invention enables conversion of ‘implicit’ decimal notation in EDI to ‘explicit’ notation in generated XML.

In an exemplary non-limiting implementation, EDI encoded files are parsed and a translator generates XML by converting the data from EDI Nn data type representations to decimal notations, or vice versa during serializing/generation of EDI. Based on configuration settings (e.g., Validation Tab/Convert Implied Decimal Format Nn to Base 10 Numeric Value=True), the invention converts an implied decimal point to a base 10 numeric value. Another example includes a transmitted EDI value of 1234 specified as numeric type N2. With the intelligent translation of the invention, the value is converted to 12.34 in the generated XML.

In other exemplary, non-limiting aspects of the invention, XML Nodes are named based of qualifier information. For instance, an EDI data dictionary defines reusable elements. An example is an ADD record used to provide address information. In any given Purchase Order, the ADD segment is reused multiple times to convey address information relating to ship location, invoice location, confirmation location, etc.

An EDI Purchase Order may thus contain multiple ADD segments each qualified by a number to denote the usage. To elaborate, the EDI encoding might appear as follows:

ST*...
...
ADD*1
ADD*2
ADD*3
.....
SE

Where in ADD*1 is the ship to address; ADD*2 is the bill to address; ADD*3 is the Ship Notice address and so on. Based off configurable parameters, the invention thus reviews the identifier information relating to certain pre-identified records and appropriately names them. After processing, the SmartXML generated from the above EDI encoding might appear as follows:

| | |
|---|---|
| <ST> .... </ST> | |
| ... | |
| <ADD1_ShipToAddress>.... | </ADD1_ShipToAddress> |
| <ADD2_BillToAddress>.... | </ADD2_BillToAddress> |
| <ADD2_ShipNoticeAddress>.... | </ADD3_ShipNoticeAddress> |
| .............. | |
| <SE> .... </SE> | |

In this regard, SmartXML is handled by EDI messaging engine whereby the engine allows parsing EDI segments with identical SegmentIDs (having different qualifier content) into unique XML records. In one non-limiting implementation, this is controlled by an annotation called “trigger_field” defined for XSD Schemas. For example, an N1 segment as defined by the X12 standard is used to convey name information. When the N1 segment contains the qualifying element “BT” (at data element N1.1), a bill-to name is signified by the X12 standard. Similarly, the qualifying element “ST” signifies a ship-to name with the X12 standard.

The X12 standard specifies that segments use coded fields in the first data element after the SegmentID to define the segment's business usage meaning. Understanding that meaning, however, is left to interpretation by a custom business application. In contrast, the invention advantageously enables this ‘mapping’ as a value added service of the translation process, and thereby generating smart XML that can be understood by any application without requiring an understanding of the cryptic EDI encoding rules.

In summary of the presently described non-limiting implementation of the invention, the trigger_field annotation enables an EDI engine provisioned according to the invention to parse the contents of each segment to unique XML tags. For instance, with the trigger fields of the invention, the parser can go from: <NAME>(N1 BT Content) (N1 ST Content)</NAME> to: <SHIP-TO-NAME>(N1 ST Content)</SHIP-TO-NAME> and <BILL-TO-NAME>(N1 BT Content)</BILL-TO-NAME>.

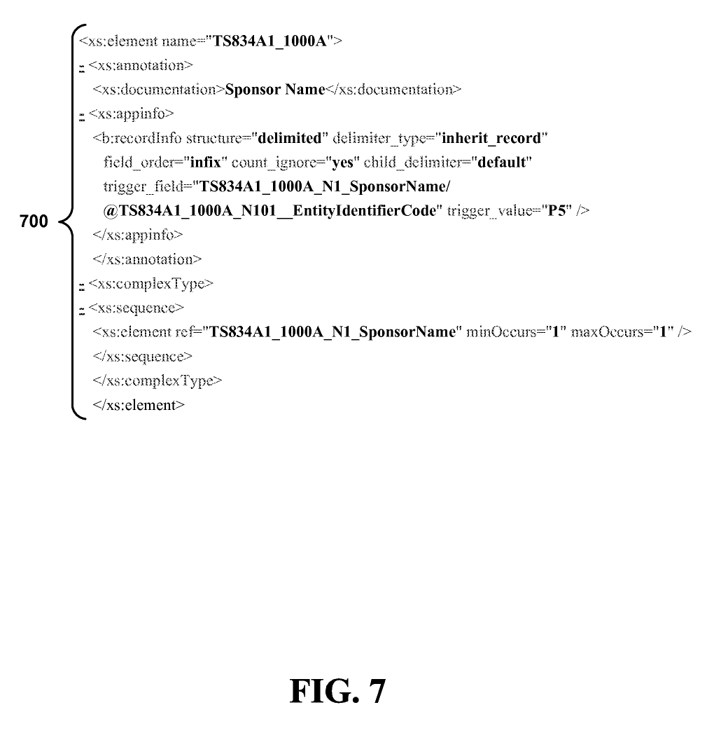

In an exemplary non-limiting process, the EDI engine, when it encounters the trigger type ‘segment’ via appropriate annotation, interprets the value in the trigger field during parsing and matches instance content with the node in the schema that has the corresponding trigger value(s) and appropriately generates the XML Tag. Triggers extend to loop interpretation as well because the trigger segment (i.e., the segment housing the trigger field) is the first segment in the loop. Triggers are also supported on segments that may be nested inside a loop. An exemplary implementation of the Trigger Field annotation from an 834 Schema is illustrated by XML representation 700 of FIG. 7.

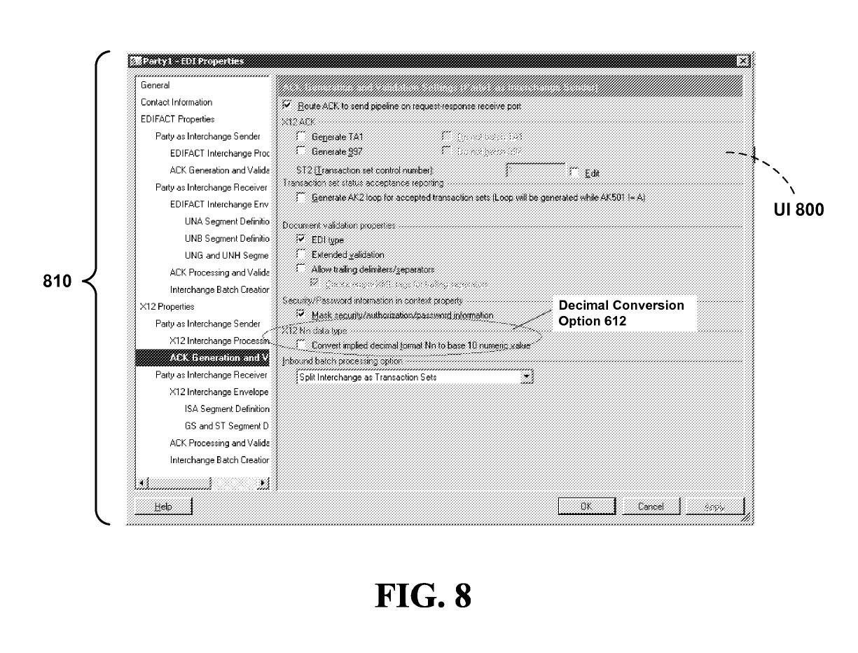

As discussed, the invention enables generation of the Interchange XML via configurable settings, as shown via configuration option 812 of a configuration component 810 as represented in UI 900 of FIG. 8. By switching the configuration options, a user can optionally apply more intelligence to the XML generated by the translation process, or vice versa when translating XML to EDI.

### Supplemental Context Regarding EDI Messaging Systems

EDI is the exchange of structured information, by agreed upon messaging standards, from one computer or computer application to another by electronic means with minimal human intervention. Based on approved formatting standards and schemas, EDI is one of the ways businesses exchange computer-to-computer business information. For example, millions of companies around the world transmit and store data associated with business transactions (e.g., purchase orders, shipping/air bills, invoices, or the like) using EDI to conduct commerce.

EDI may thus be defined as computer-to-computer exchange of business information using ‘approved’ formatting standards, referring to specific interchange methods agreed upon by national or international standards bodies for the transfer of business transaction data. One typical application for EDI messaging is the automated purchase of goods and services, though EDI messages are by no means limited to any particular kind of business data. In this regard, millions of companies around the world use EDI to conduct commerce. In raw format, EDI data is transmitted as delimited files (without self describing tags) and therefore the encoding rules enforce very strict formatting rules to ensure the destination application is able to successfully parse and consume the information for down stream processing.

Organizations that send or receive documents from each other are referred to as “trading partners” in EDI terminology. The trading partners agree on the specific information to be transmitted and how it should be used. Service providers provide global platforms (also known as trading grids) to connect and integrate “business partners” around the world. They provide integration platforms that make the exchange of EDI (or XML) documents transparent and easy between diverse constituents. These providers also track and reconcile documents to reduce errors and improve supply chain performance.

EDI translation software provides the interface between the internal system and the common standards and applies to both “inbound” documents and “outbound” documents. Translation software may also utilize other methods or file formats translated to or from EDI.

It can be appreciated by those of skill in the art that the structured information of EDI files can also be represented with the extensible markup language (XML), and vice versa. Despite the use of EDI being somewhat unheralded relative to its counterpart XML, EDI files are still the data format used in a majority of electronic commerce transactions in the world.

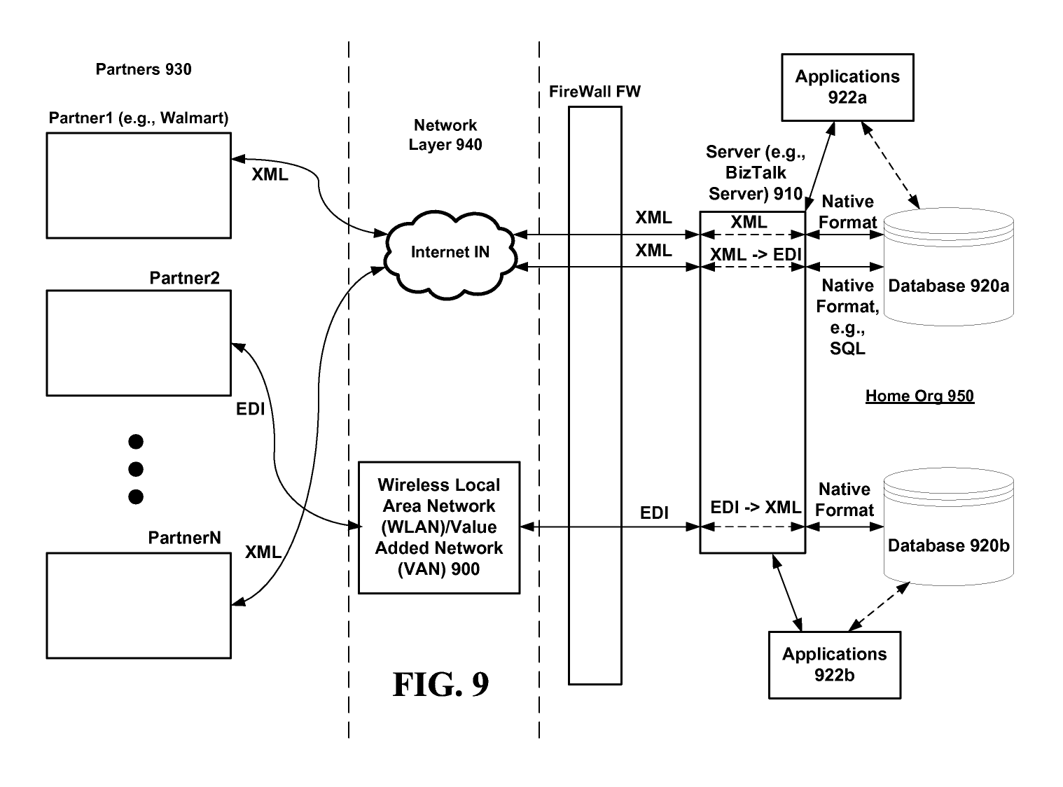

In the exemplary EDI system for a home organization 950 shown in FIG. 9, typically server software, such as Microsoft's BizTalk Server 910 can be deployed to interact outside of the home organization 950 via network layer 940 and to interface with databases 920a, 920b, etc. so that various applications 922a, 922b, etc., can interact with the automated storage of business records received by databases 920a, 920b, etc. EDI files or XML representations of EDI files can be received via Internet IN, or a wireless local area network (WLAN) or value added network (VAN) 900 of network layer 940, e.g., through firewall FW, and such EDI/XML messages can be received from any of a variety of trading partners 930, i.e., partner1, partner2, . . . , partnerN. Server 910 can handle any of the necessary conversions and parsing of EDI files or XML representations thereof, and any conversions to or from a native database format, such as SQL.

Typically, when an EDI messages are received, a server receiving the EDI messages can answer in terms of an acknowledgment of receipt of the EDI messages to its trading partner. The server will specify whether the EDI message is invalid according to the schema, and if invalid, will specify why, or the server will specify that the EDI message was accepted, accepted with errors or rejected.

Internet IN has enabled EDI transactions to be transmitted between trading partners in an even more efficient manner. Internet IN provides business and government agencies with an environment that is open, fast, cost effective, and widely accepted and used.

VAN 900 is a mechanism that facilitates the transfer of electronic data between trading partners. A VAN 900 can be thought of as a post office, or a dedicated pipe, which allows an entity to send EDI formatted data to one of their trading partners at any time. The VAN 900 will hold the file of transmitted transactions until the trading partner to whom it is addressed retrieves it at a later time.

The EDI standards were designed to be independent of lower level technologies and can be transmitted using Internet protocols, such as the file transfer protocol (FTP), telnet and email, as well as private networks, such as value-added networks (VANs). EDI documents contain the same data that would normally be found in a paper document used for the same organizational function. For example, an EDI ship-from-warehouse order might be used by a manufacturer to tell a warehouse to ship product(s) to a retailer. It typically has a ship to address, bill to address, a list of product numbers (e.g., a UPC code) and quantities. It may also have other information if the parties agree to include it. However, EDI is not confined to just business data directly related to trade, rather but encompasses all fields such as medicine (patient records, laboratory results, etc.), transport (container and modal information, etc.), engineering and construction, etc., i.e., anywhere a first entity may wish to automate the exchange of data with another entity.

In a typical EDI transaction model, a large business entity or an EDI integration broker trades with numerous partners and has the technical capability to handle numerous EDI transaction data in various EDI formats and schemas. These entities, also known as “hubs,” transact with one or more suppliers, also known as “spokes.” Each of the spokes typically is a relatively small business entity that is only capable of dealing with one hub.

Before the spokes attempt to initiate transactions via EDI with the hub, the hub typically transmits various EDI schemas to the spokes so that the spokes can properly format the EDI transactions according to the EDI schemas.

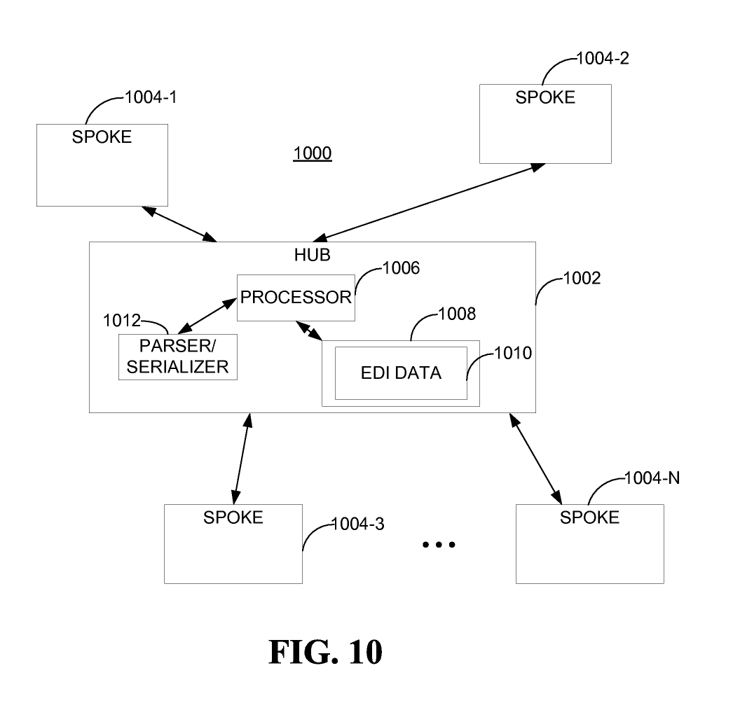

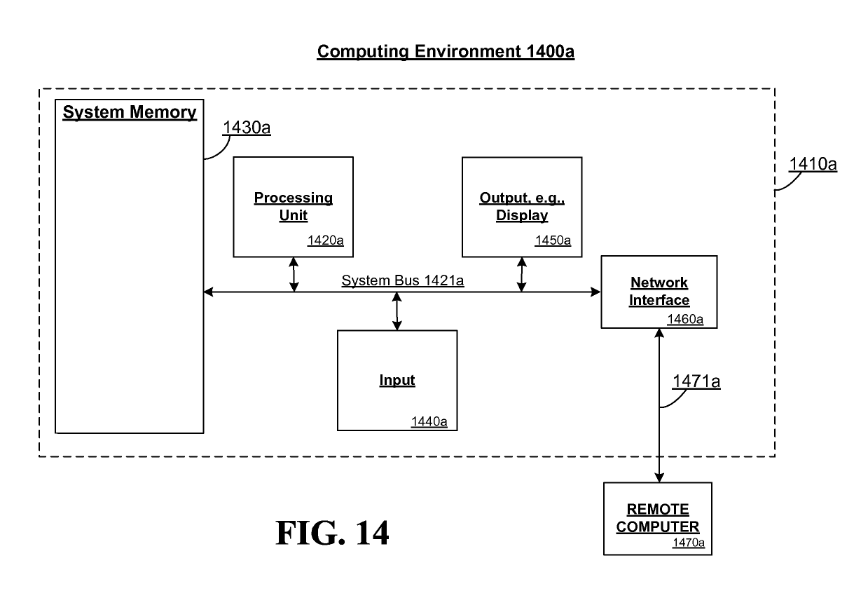

FIG. 10 is a block diagram illustrating a system for conducting EDI transactions according to exemplary non-limiting embodiments of the invention. A system 1000 is illustrated for conducting EDI transactions. System 1000 includes a hub 1002 linked to and communicating with one or more spokes (e.g., spokes 1004-1, 1004-2, 1004-3, . . . , 1004-N). In one embodiment, the hub 1002 includes a server computer or a computing device serving one or more processors (e.g., processor 1006) or processing units for executing computer-executable instructions for serving the spokes 1004. In one example, the spokes 1004 include a computing device having one or more components included in or coupled with a computer 1030, as shown in FIG. 14.

In one example, the hub 1002 also includes a memory area 1008 for storing one or more EDI schemas, such as an EDI schema 1010. Initially, the hub 1002 and the spokes 1004-1, 1004-2, 1004-3, . . . , 1004-N establish agreements as to the EDI formats or standards to be used for transmitting transaction data therebetween. Once the parties determine the particular EDI formats or standards to use, the hub 1002 selects the appropriate EDI schemas to be transmitted to the spokes 1004-1, 1004-2, 1004-3, . . . , 1004-N. In another example, the hub 1002 may choose to select all EDI schemas for all types of transactions, such as purchase orders, bills of lading, invoices, payrolls, or the like, to the spokes 1004-1, 1004-2, 1004-3, . . . , 1004-N.

Although the communications between the hub 1002 and the spokes 1004-1, 1004-2, 1004-3, . . . , 1004-N can be a private or public communications network, a wired or wireless network, the spokes 1004-1, 1004-2, 1004-3, . . . , 1004-N typically lack the hardware resources to handle large amount of EDI schemas sent from the hub 1002. In addition, the type and bandwidth of computing network communications for the spokes 1004-1, 1004-2, 1004-3, . . . , 1004-N are not equipped to handle such demand imposed by the thousands of EDI schemas, which can reach several Gigabytes in data size.

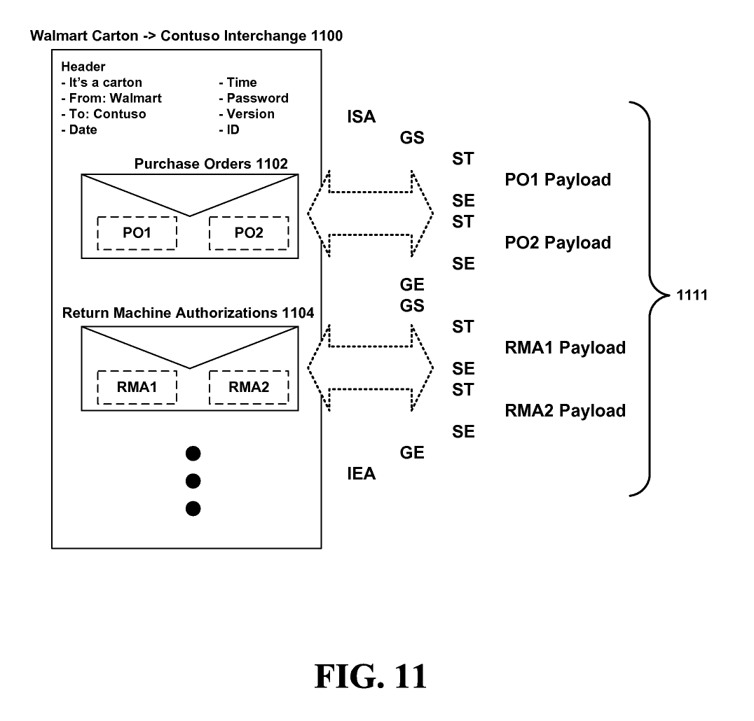

FIG. 11 in turn illustrates that an organization can generate an interchange 1100—a sort of carton for EDI messages—which includes a plurality of EDI messages. Interchange 1100 typically includes a header which includes a type of document, from whom the document originated, to whom the document is addressed, the date, the time, any password information, version information, identification information, and the like. Then the interchange 1100 lists a series of purchase orders 1102 and return machine authorizations (RMAs) 1104, conceptually shown as envelopes in the carton. In turn, each envelope conceptually represents one or more individual EDI files, or messages. For instance, purchase orders 1102 include individual purchase orders PO1 and PO2, and RMAs 1104 include RMAs RMA1 and RMA2, and so on.

In turn, there is a flat file native EDI format that corresponds to this conceptual relationship between carton->envelopes->messages. As illustrated by shell 1111 corresponding to the conceptual representation, the ISA <-> IEA indent level represents the beginning and end of the interchange (carton). The GS and GE indent levels represent the beginning and end of any envelopes within the carton, and the ST and SE indent levels represent the beginning and end of any messages within an envelope, i.e., inbetween any ST and SE will be an individual message payload, such as PO1 Payload, PO2 Payload, RMA1 Payload and RMA2 Payload.

There are several advantages of using EDI all of which provide distinct benefits to the user. One of the most notable benefits to using EDI is the time-saving capability it provides. By eliminating the process of distributing hard copies of information throughout the company, easy access to electronic data simplifies inter-department communication. Also, another time-savings advantage is the ability to track the origin of all information therefore significantly reducing time spent on corresponding with the source of the information.

Another benefit for the user of this information system is the ultimate savings in costs for an organization. Although the initial set-up costs may seem high, the overall savings received in the long run ensures its value. For any business, regardless of its size, hard-copy print outs and document shipping costs add up. EDI allows for a paper-less exchange of information reducing handling costs and worker productivity that is involved with the organization of paper documents.

EDI has another strong advantage over paper-based information exchange, which has to do with accuracy of information. When the information is already stored electronically, it speeds up an organizations ability to check for accuracy and make any necessary corrections as the data is already input to the system. Also, unlike paper-based methods, EDI allows for the ability to send and receive information at any time thereby tremendously improving an organizations ability to communicate quickly and efficiently.

A disadvantage of using EDI involves the initial set-up. The preliminary expenses and time that arise from the implementation, customization and training can be costly. However, as EDI systems continue to improve, such as by using the batching membership evaluation techniques of the invention, such disadvantage is disappearing as ease of use increase.

### EDIFACT and X12 Standards for EDI Documents

There are two major sets of EDI standards which can be used to generate and receive/process EDI messages: the United Nations Electronic Data Interchange for Administration, Commerce and Transport, which is a translation of UN/EDIFACT (“EDIFACT”) and the American National Standards Institute's (ANSI) Accredited Standards Committee (ASC) X12 (“X12”). Both used worldwide, X12 tends to be more popular in North America than EDIFACT. These standards prescribe the formats, character sets, and data elements used in the exchange of documents and forms, such as invoices and purchase orders, e.g., purchase orders are called “ORDERS” in EDIFACT and “850s” in X12.

Whichever selected, the standard dictates which pieces of information are mandatory for a particular document, which pieces are optional and gives the rules for the structure of the document. In this regard, with optional pieces, two EDI documents can follow the same standard and contain different sets of information. For example, a food company might indicate a particular product expiration date while a clothing manufacturer might choose to send color and size information.

For illustrative purposes only, the following is an example EDIFACT message, for instance, that might be used to answer to a product availability request:

UNB+IATB:1+6XPPC+LHPPC+VV40101:0VV50+1’
UNH+1+PAORES:VV3:1:IA’
MSG+1:45’
IFT+3+?*XYZCOMPANY AVAILABILITY?*’
ERC+A7V:1:AMD’
IFT+3+NO MORE FLIGHTS'
ODI’
TVL+2404VV3:1000::1220+FRA+JFK+DL+400+C’
PDI++C:3+Y::3+F::1’
APD+74C:0:::6++++++6X’
TVL+2404VV3:1740::2030+JFK+MIA+DL+081+C′
PDI++C:4’
APD+EM2:0:1630::6+++++++DA’
UNT+13+1’
UNZ+1+1’

wherein the following symbols have the following meanings:

′ is a segment terminator;

+ is a data element separator;

: is a component data element separator;

* is a repetition separator; and

? is a release character.

To explain the information contained in some of the above segments, the segment of the above exemplary EDI file designated by “UNH+1+PAORES:VV3:IA′” is the header segment. A header segment is required at the start of every EDI message. With this particular file segment, the message name and version is specified as PAORES VV3 revision 1 and it was defined by the organization IATA. The segment of the above exemplary EDI file designated by “IFT+3+NO MORE FLIGHTS′” is an ‘Interactive Free Text’ segment containing the text ‘NO MORE FLIGHTS.’ The segment of the above exemplary EDI file designated by “UNT+13+1′” is the tail segment, whereby it is indicated that the message sent contains 13 segments.

EDIFACT files have a hierarchical structure. The top level element is referred to a message. A message is a sequence of groups and segments. A group or segment can be mandatory (M) or conditional (C) and can be specified to repeat, for example CVVVV would indicate between 0 and VVVV repetitions of a segment or group, whereas MVVVV would mean between 1 and VVVV repetitions.

A group, like a message, is a sequence of segments or groups. The first segment/group beneath a group must be mandatory. If the logic of the situation demands it is conditional, then the group itself should be made conditional instead.

In exemplary practice, where the X12 standard is used, X12 schemas use the following format:

X12 Schemas=X12_{Version}_{TsId},

which indicates that:

1) all X12 schemas have a root node name that starts with X12;

2) “Version” represents the version information of the document, and it is a dynamic piece of information which is configuration or instance driven; and

3) “TsId” stands for “transaction ID” of the document being processed and is read from the input instance.

In exemplary practice, where the EDIFACT standard is used, EDIFACT schemas use the following format:

EDIFACT Schemas=Efact_{Version}_{Tsid},

which indicates that:

1) all EDIFACT schemas have root node name that starts with Efact;

2) “Version” represents the version information of the document, and it is a dynamic piece of information which is configuration or instance driven; and

3) “TsId” stands for “transaction ID” of the document being processed and is read from the input instance.

Accordingly, the root node name can be used to distinguish between X12 and EDIFACT representations of structured information.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for translating EDI transaction sets to XML in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for translating EDI transaction sets to XML in accordance with the invention.

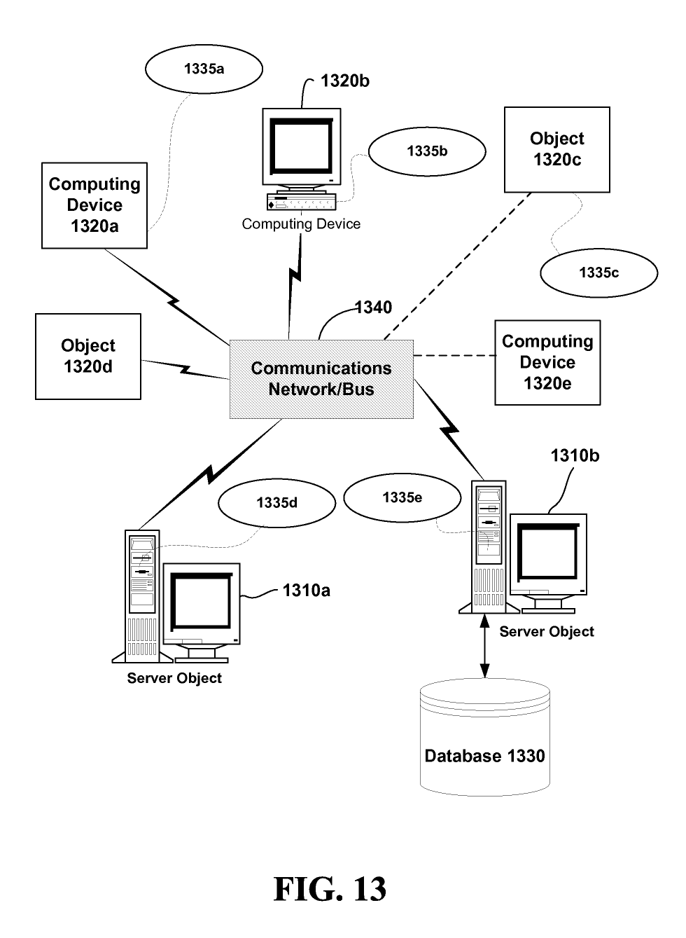

FIG. 13 provides a schematic diagram of an exemplary networked or distributed computing environment. The distributed computing environment comprises computing objects 1310a, 1310b, etc. and computing objects or devices 1320a, 1320b, 1320c, 1320d, 1320e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1340. This network may itself comprise other computing objects and computing devices that provide services to the system of FIG. 13, and may itself represent multiple interconnected networks. In accordance with an aspect of the invention, each object 1310a, 1310b, etc. or 1320a, 1320b, 1320c, 1320d, 1320e, etc. may contain an application that might make use of an API, or other object, software, firmware and/or hardware, suitable for use with the systems and methods for translating EDI transaction sets to XML in accordance with the invention.

It can also be appreciated that an object, such as 1320c, may be hosted on another computing device 1310a, 1310b, etc. or 1320a, 1320b, 1320c, 1320d, 1320e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to translating EDI transaction sets to XML according to the present invention.

The Internet commonly refers to the collection of networks and gateways that utilize the Transmission Control Protocol/Internet Protocol (TCP/IP) suite of protocols, which are well known in the art of computer networking. The Internet can be described as a system of geographically distributed remote computer networks interconnected by computers executing networking protocols that allow users to interact and share information over network(s). Because of such widespread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 13, as an example, computers 1320a, 1320b, 1320c, 1320d, 1320e, etc. can be thought of as clients and computers 1310a, 1310b, etc. can be thought of as servers where servers 1310a, 1310b, etc. maintain the data that is then replicated to client computers 1320a, 1320b, 1320c, 1320d, 1320e, etc., although any computer can be considered a client, a server, or both, depending on the circumstances. Any of these computing devices may be processing data or requesting services or tasks that may implicate the translation of EDI transaction sets to XML in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for translating EDI transaction sets to XML of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 13 illustrates an exemplary networked or distributed environment, with server(s) in communication with client computer (s) via a network/bus, in which the present invention may be employed. In more detail, a number of servers 1310a, 1310b, etc. are interconnected via a communications network/bus 1340, which may be a LAN, WAN, intranet, GSM network, the Internet, etc., with a number of client or remote computing devices 1320a, 1320b, 1320c, 1320d, 1320e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to translate groups of EDI transaction sets to XML.

In a network environment in which the communications network/bus 1340 is the Internet, for example, the servers 1310a, 1310b, etc. can be Web servers with which the clients 1320a, 1320b, 1320c, 1320d, 1320e, etc. communicate via any of a number of known protocols such as HTTP. Servers 1310a, 1310b, etc. may also serve as clients 1320a, 1320b, 1320c, 1320d, 1320e, etc., as may be characteristic of a distributed computing environment.

As mentioned, communications may be wired or wireless, or a combination, where appropriate. Client devices 1320a, 1320b, 1320c, 1320d, 1320e, etc. may or may not communicate via communications network/bus 14, and may have independent communications associated therewith. For example, in the case of a TV or VCR, there may or may not be a networked aspect to the control thereof. Each client computer 1320a, 1320b, 1320c, 1320d, 1320e, etc. and server computer 1310a, 1310b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1310a, 1310b, 1320a, 1320b, 1320c, 1320d, 1320e, etc. may be responsible for the maintenance and updating of a database 1330 or other storage element, such as a database or memory 1330 for storing data processed or saved according to the invention. Thus, the present invention can be utilized in a computer network environment having client computers 1320a, 1320b, 1320c, 1320d, 1320e, etc. that can access and interact with a computer network/bus 1340 and server computers 1310a, 1310b, etc. that may interact with client computers 1320a, 1320b, 1320c, 1320d, 1320e, etc. and other like devices, and databases 1330.

### Exemplary Computing Device

As mentioned, the invention applies to any device wherein it may be desirable to translate EDI transaction sets to XML. It should be understood, therefore, that handheld, portable and other computing devices and computing objects of all kinds are contemplated for use in connection with the present invention, i.e., anywhere that a device may translate EDI transaction sets to XML or otherwise receive, process or store EDI data or corresponding XML representations. Accordingly, the below general purpose remote computer described below in FIG. 14 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 14 thus illustrates an example of a suitable computing system environment 1400a in which the invention may be implemented, although as made clear above, the computing system environment 1400a is only one example of a suitable computing environment for a media device and is not intended to suggest any limitation as to the scope of use or functionality of the invention. Neither should the computing environment 1400a be interpreted as having any dependency or requirement relating to any one or combination of components illustrated in the exemplary operating environment 1400a.

With reference to FIG. 14, an exemplary remote device for implementing the invention includes a general purpose computing device in the form of a computer 1410a. Components of computer 1410a may include, but are not limited to, a processing unit 1420a, a system memory 1430a, and a system bus 1421a that couples various system components including the system memory to the processing unit 1420a. The system bus 1421a may be any of several types of bus structures including a memory bus or memory controller, a peripheral bus, and a local bus using any of a variety of bus architectures.

Computer 1410a typically includes a variety of computer readable media. Computer readable media can be any available media that can be accessed by computer 1410a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1410a. Communication media typically embodies computer readable instructions, data structures, program modules or other data in a modulated data signal such as a carrier wave or other transport mechanism and includes any information delivery media.

The system memory 1430a may include computer storage media in the form of volatile and/or nonvolatile memory such as read only memory (ROM) and/or random access memory (RAM). A basic input/output system (BIOS), containing the basic routines that help to transfer information between elements within computer 1410a, such as during start-up, may be stored in memory 1430a. Memory 1430a typically also contains data and/or program modules that are immediately accessible to and/or presently being operated on by processing unit 1420a. By way of example, and not limitation, memory 1430a may also include an operating system, application programs, other program modules, and program data.

The computer 1410a may also include other removable/non-removable, volatile/nonvolatile computer storage media. For example, computer 1410a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1421a through a non-removable memory interface such as an interface, and a magnetic disk drive or optical disk drive is typically connected to the system bus 1421a by a removable memory interface, such as an interface.

A user may enter commands and information into the computer 1410a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1420a through user input 1440a and associated interface(s) that are coupled to the system bus 1421a, but may be connected by other interface and bus structures, such as a parallel port, game port or a universal serial bus (USB). A graphics subsystem may also be connected to the system bus 1421a. A monitor or other type of display device is also connected to the system bus 1421a via an interface, such as output interface 1450a, which may in turn communicate with video memory. In addition to a monitor, computers may also include other peripheral output devices such as speakers and a printer, which may be connected through output interface 1450a.

The computer 1410a may operate in a networked or distributed environment using logical connections to one or more other remote computers, such as remote computer 1470a, which may in turn have media capabilities different from device 1410a. The remote computer 1470a may be a personal computer, a server, a router, a network PC, a peer device or other common network node, or any other remote media consumption or transmission device, and may include any or all of the elements described above relative to the computer 1410a. The logical connections depicted in FIG. 14 include a network 1471a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1410a is connected to the LAN 1471a through a network interface or adapter. When used in a WAN networking environment, the computer 1410a typically includes a communications component, such as a modem, or other means for establishing communications over the WAN, such as the Internet. A communications component, such as a modem, which may be internal or external, may be connected to the system bus 1421a via the user input interface of input 1440a, or other appropriate mechanism. In a networked environment, program modules depicted relative to the computer 1410a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for translating EDI transaction sets to XML in accordance with the invention may be included in, supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the systems and methods for translating EDI transaction sets to XML of the invention. The invention contemplates the use of the invention from the standpoint of an API (or other software object), as well as from a software or hardware object that receives and/or translates EDI transaction sets to XML in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to translate EDI transaction sets to XML. For instance, a translator provided in accordance with any of the embodiments of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the translation capabilities of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 3 and 5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for translating EDI transaction sets to XML. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for translating electronic data interchange (EDI) messages to one or more extensible markup language (XML) representations, including:
configuring at least one translation option that applies at least one additional rule to translating EDI formatting to XML for a given EDI encoding context;
receiving at least one EDI transaction set; and
translating the at least one EDI transaction set to at least one XML representation wherein the translating includes applying the at least one additional rule to the EDI transaction set when translating to the at least one XML representation.

2. The method of claim 1, wherein said configuring includes configuring at least one translation option that applies at least one additional rule that affects said translating based on the encoding context of the at least one EDI transaction set.

3. The method of claim 1, wherein said translating includes replacing implicitly specified information from the at least one EDI transaction set with explicit information in the at least one XML representation.

4. The method of claim 3, wherein said translating includes replacing, based on EDI encoding rules, EDI encoded information from the at least one EDI transaction set with an explicit representation of the EDI encoded information in the at least one XML representation.

5. The method of claim 3, wherein said translating includes replacing an implicitly specified position of a decimal point from the at least one EDI transaction set with an explicit decimal point in the at least one XML representation.

6. The method of claim 1, wherein said translating includes annotating the at least one XML representation with descriptive tags.

7. The method of claim 1, wherein said translating includes annotating at least one XML representation based on at least one trigger field.

8. The method of claim 1, wherein said translating includes translating an address element by annotating an address element name tag in the at least one XML representation with a descriptive annotation that identifies a type of address.

9. A computer readable medium comprising computer executable instructions for performing the method of claim 1.

10. A computing device comprising means for performing the method of claim 1.

11. A server object that interfaces to one or more electronic data interchange (EDI) trading partners for transmitting and receiving EDI messages, including:
a translation component that translates at least one extensible markup language (XML) representation to an interchange including at least two transaction sets; and
a configuration component that receives configuration input that configures the translation component according to at least one translation option that causes said translation component to translate the at least one XML representation with at least one additional rule that applies to at least one EDI encoding context represented in the at least one XML representation.

12. The server object of claim 11, wherein the configuration component receives configuration input that causes said translation component to replace explicitly specified information from the at least one XML representation with implicit information in the at least two EDI transaction sets.

13. The server object of claim 12, wherein the configuration component receives configuration input that causes said translation component to replace an explicit decimal point from the at least one XML representation with an implicitly specified position of a decimal point in the at least two EDI transaction sets.

14. The server object of claim 11, wherein the configuration component receives configuration input that causes said translation component to remove descriptive annotations in the tags of the at least one XML representation

15. The server object of claim 14, wherein the configuration component receives configuration input that causes said translation component to ignore a descriptive annotation that identifies the type of address represented by an address element in the at least one XML representation.

16. The server object of claim 11, wherein the configuration component further comprises a user interface component for displaying a user interface for receiving said configuration input.

17. The server object of claim 11, further comprising:
a storage interface for interfacing to relational storage for at least one of storing the interchange or retrieving the at least one XML representations.

18. An electronic data interchange (EDI) messaging system, including:
a translator for translating at least one electronic data interchange (EDI) transaction set to at least one extensible markup language (XML) file or for translating at least one XML file to at least one EDI transaction set; and
a configuration user interface (UI) for configuring the translating performed by the translator, wherein the configuration UI includes a UI portion that enables an option for translating according to at least one rule based on a mapping from implicit information represented by an EDI encoding convention to an explicit representation of the implicit information in XML form.

19. The EDI messaging system of claim 18, wherein said UI portion enables an option whereby the translator replaces implicitly specified decimal information from the at least one EDI transaction set with explicit decimal information in the at least one XML file.

20. The EDI messaging system of claim 18, wherein said UI portion sets an option whereby the translator annotates element names of the at least one XML file explicitly with at least one descriptive annotation based on implicit information encoded according to the EDI encoding convention.
